(19) United States
(12) Patent Application Publication
(10) Pub. No.: US 2005/0089008 A1
(43) Pub. Date: Apr. 28, 2005

(54) Method for providing mobile packet data service in mobile communication system

(75) Inventors: Ho-Cheol Choo, Seoul (KR); Seok-Joon Jang, Seoul (KR)

Correspondence Address: OBLON, SPIVAK, MCCLELLAND, MAIER & NEUSTADT, P.C., 1940 DUKE STREET, ALEXANDRIA, VA, 22314, US

(73) Assignee: CURITEL COMMUNICATIONS, INC.

(21) Appl. No.: 10/747,090

(22) Filed: Dec. 30, 2003

(30) Foreign Application Priority Data
Oct. 28, 2003 (KR) 2003-75624

(51) Int. Cl. H04J 3/24

(52) U.S. Cl. 370/349

(57) ABSTRACT

A method for performing packet data communication between a mobile station (MS) and a packet data serving node (PDSN) in the next generation mobile communication network. In accordance with the packet data communication method, a traffic channel is set up between the MS and a radio network (RN), and a packet connection is set up between the RN and the PDSN. The MS and the PDSN exchange a data packet by means of an Internet protocol (IP) session without setting up a point-to-point protocol (PPP) layer connection. Therefore, unnecessary bytes of a PPP packet can be removed, and a negotiation process for setting up a PPP layer connection and time delay due to the negotiation process can be removed. An operation of transmitting IP information for the MS that is conventionally performed in the PPP layer connection setup process is performed using a broadcast/multicast Internet protocol (IP) packet, in a packet data service method in the mobile communication network.

### BACKGROUND OF THE INVENTION

1. Field of the Invention

The present invention relates to a data communication technology in the next generation mobile communication network, and more particularly to a method for performing packet data communication between a mobile station (MS) and a packet data serving node (PDSN).

2. Description of the Related Art

FIG. 1 is a schematic block diagram illustrating the architecture of a conventional third Generation Partnership Project 2 (3GPP2) network. For example, a mobile station (MS) is a mobile communication terminal such as a mobile phone, a wireless application protocol (WAP) terminal, a mobile communication modem or etc.

A radio access network (RAN) 20 called a radio core network between communication carriers includes a base station transceiver system (BTS) 21, a base station controller (BSC) 23 and a packet control function (PCF) entity 25. Further, the RAN 20 manages the mobility of the MS by means of a visitor location register (VLR) and a home location register (HLR) coupled to a mobile switching center (MSC) and provides an authentication function. Furthermore, the RAN 20 controls a data transmission between a mobile station (MS) 10 and a packet data serving node (PDSN) 40, is responsible for a buffering function when data is sent to the MS 10 from an Internet protocol (IP) network.

The RAN 20 sets up a virtual connection based upon a generic routing encapsulation (GRE) protocol with PDSN 40 when a basic authentication procedure associated with a data call has been completed.

In detail, the BSC 23 controls and manages at least one BTS 21, and performs traffic and signalling management relating to a call process, mobility management, etc.

The PCF entity 25 provides a radio packet (RP) interface between the RAN 20 and an Internet protocol (IP) network so that data from the MS 10 can be coupled to the PDSN 40 through the BSC 23. Further, the PCF entity 25 processes a virtual link connection for a data transmission on a subscriber-by-subscriber basis in the RP interface, and provides a tunneling function by performing an encapsulation and decapsulation operation for user data through the GRE protocol. Furthermore, the PCF entity 25 provides a buffering function and a packet segmentation function so that link layer packet sent from the PDSN 40 to the MS 10 can be transmitted through air interface. The PCF entity 25 can be located within the BSC 23, but is typically implemented as an independent system.

The PDSN 40 processes a packet received from the PCF entity 25. Further, the PDSN 40 serves as an end point for performing a point-to-point protocol (PPP) with the MS 10. Furthermore, the PDSN 40 receives an identity (ID) and a password from a subscriber for a packet service and then transmits the received ID and password of the subscriber to a remote authentication dial-in user service (RADIUS) server 50 so that the RADIUS server 50 can authenticate the subscriber on the basis of the transmitted ID and password.

The RADIUS server 50 performs authentication, authorization and accounting functions. That is, the RADIUS server 50 performs subscriber authentication and verifies authority for the packet data of communication service subscribers, and billing functions for service usage. The RADIUS server 50 processes an authentication request from the PDSN 40 and processes a billing message.

A home agent (HA) 60 transmits a registration reply message through allowing use of a fixed IP address or assigning an dynamic IP address to the MS 10 when it has received a registration request message from the MS 10. e When a PDSN area for the MS 10 is changed, the MS 10 notifies the HA 60 of the changed PDSN area.

A dynamic host configuration protocol (DHCP) sever/domain name system (DNS) server 70 automatically assigns IP addresses to users. Thus, the users do not need to directly set the IP addresses. The DHCP server/DNS server 70 is used for setting a network configuration environment associated with an IP address, domain name, etc.

The DNS server 70 is used for converting a host name into an IP address or converting the IP address into the host name. According to the Request for Comments (RFC) 2136 protocol, the DNS server 70 can change and update an IP address corresponding to a specific host name through a DNS update message.

When the MS 10 requests a packet data service in the above-described mobile communication network, the PDSN 40 for transmitting packet data is determined by the BSC 23/PCF entity 25. At this point, a radio traffic channel and a radio link protocol (RLP) are set between the MS 10 and the BSC 23. An A8 traffic link between the BSC 23 and the PCF entity 25, and an A10 radio-packet (R-P) link between the PCF entity 25 and the PDSN 40 are established respectively so that PPP layer data can be communicated between the MS 10 and the PDSN 40. An active state of the packet data service is a state in which the MS 10 holds the radio traffic channel, maintains an RLP link and the A8 traffic link, and transmits/receives packet data.

FIG. 2 is a schematic diagram illustrating a protocol stack for a data call connection in a conventional mobile communication system. As shown in FIG. 2, the protocol stack includes a physical layer, a radio link protocol (RLP) layer, a point-to-point protocol (PPP) layer, an Internet protocol (IP) layer, a transmission control protocol (TCP) layer, a user datagram protocol (UDP) layer, etc.

The physical layer is the lowest-level layer in an open system interconnection (OSI) protocol reference model defined by the International Standard Organization (ISO). The physical layer performs electrical, mechanical and functional procedures, and corresponds to IS-95B/2000 protocol 109.

A RLP 107 is a communication protocol for providing reliable data transmission between the MS and the BS through a radio channel. The RLP 107 provides the reliable radio channel using an automatic repeat request (ARQ) scheme for requesting that data with an error in a data transmission be retransmitted.

A PPP 105 is a communication protocol used when the Internet is accessed by a high-speed modem through a leased line or public line. An IP 103 interconnects different communication networks that operate separately. That is, the IP 103 is a communication protocol for interconnecting the separate communication networks.

A TCP is one of frequently used network protocols. Where data is transmitted through a network, the data is segmented in units of packets and then transmitted. The TCP implements data packet flow control and error detection, while the IP implements point to point data packet transmission.

A UDP is one of the upper IP layer protocols for TCP/IP network, and is a transport layer protocol defined in STD 6, RFC 768 for Internet. The UDP transmits data in user-defined datagram units.

The MS 10 establishes a session setup with a communication network connection part such as the PCF entity 25 through a physical layer and a RLP layer, and with a packet data transmission part such as the PDSN 40 through a relay layer and a PPP layer.

Furthermore, the MS 10 establishes a session with a additional service providing part through the relay layer, the PPP layer and the TCP/IP or UDP.

Applications allowing the user to access the wireless Internet using a mobile communication terminal are a browser, terminal platforms (e.g., JAVA, BREW, GVM, etc.) and others.

FIG. 3 is a flow chart illustrating a connection procedure for a packet data service in a conventional mobile communication network. As shown in FIG. 3, the connection procedure for the packet data service is initiated when a mobile station (MS) transmits an origination message to a base station (BS) at step 201. The BS transmits, to the MS, a “BS ACK Order” message indicating that the BS has received the origination message at step 203. Then, the BS transmits a “CM Service Request” message to a mobile switching center (MSC) to notify the MSC of a packet call request at step 205. Then, the MSC transmits, to the BS, an “Assignment Request” message to request that the BS assign radio resources at step 207. Then, service negotiation is performed between the MS and the MSC, such that a traffic channel (TCH) is set up at step 209.

Then, the BS transmits an “A9-Setup-A8” message for packet control function (PCF) resource assignment to a PCF entity at step 211. An A8/A9 interface is used for transferring signals and user data between the BS and the PCF entity. The PCF entity sets up an A10/A11 connection for GRE session assignment with the packet data serving node (PDSN) at step 213. The A10 and A11 interfaces are used for transmitting signals and user data between the PCF entity and the PDSN. Then, the PCF entity transmits an “A9-Connect-A8” message as a response associated with PCF resource assignment to the BS at step 215. The BS transmits, to the MSC, an “Assignment Complete” message indicating that resource assignment has been completed at step 217. Then, a PPP layer connection between the MS and the PDSN is established at step 219, and a packet data session is activated at step 221. A PPP layer connection procedure includes a user authentication procedure based upon an identity (ID) and a password, IP address assignment, notification of a domain name system (DNS), etc.

The conventional mobile packet data service uses an IS-95/95B/2000 protocol for a physical layer and the PPP for a data link layer in view of the open systems interconnection (OSI) reference model defined by the International Standard Organization (ISO). Negotiation procedure and time delay for the PPP layer connection between the MS 10 and the PDSN 60 are required after a call setup for the physical layer in the conventional mobile packet data service. Furthermore, at least 7 byte per PPP packet are wasted because data is transmitted through the physical layer in unit of PPP packet. In the PPP, a transmitting unit attaches a “7E” bit pattern to the head and tail of one PPP packet so that a receiving unit can distinguish respective PPP packets. The receiving unit receives and reads data in unit of byte to recognize the “7E” bit pattern. As this operation is performed in the units of bytes, the performance of an entire system can be degraded. For this reason, the remaining information and other processes can be adversely affected during a communication process.

### SUMMARY OF THE INVENTION

Therefore, the present invention has been made in view of the above problems, and it is one object of the present invention to remove transmission of redundant information due to the implementation of a point-to-point protocol (PPP).

It is another object of the present invention to remove time delay due to a mutual conversion operation for an Internet protocol (IP) packet and a PPP packet.

It is another object of the present invention to reduce initial negotiation delay due to the exchange of necessary information for setting up a packet data connection, that is, user authentication data, an Internet protocol (IP) address, a domain name system (DNS) data.

In accordance with one aspect of the present invention, a method for providing a packet data service in a mobile communication network sets up a traffic channel between a mobile station (MS) and a radio network (RN), sets up a packet exchange between the RN and a packet data serving node (PDSN), and data packet can be exchanged through an Internet protocol(IP) session without setting up a point-to-point protocol (PPP) layer connection between the MS and the PDSN.

The above-described packet data service method not only can remove an unnecessary operation and unnecessary data, but also can remove a negotiation procedure for the PPP layer connection setup, because it does not go through a PPP layer.

In accordance with another aspect of the present invention, an operation of transmitting IP information for the MS that is conventionally performed in a PPP layer connection setup procedure is performed using a broadcast/multicast IP packet, in the packet data service method of the mobile communication network.

In particular, when the MS transmits broadcast/multicast IP packet containing information for authentication procedure for packet service to the PDSN, the PDSN requests that an authentication server such as a remote authentication dial-in user service (RADIUS) server perform an authentication procedure using the information received from the MS. At this point, the PDSN serves as an authentication client. If the authentication procedure has been successfully performed, the PDSN receives an IP address assigned by an IP address assignment procedure, and transmits the assigned IP address to the MS using the broadcast/multicast IP packet. Where a simple IP is used, the authentication server or another server performs the IP address assignment procedure. Where a mobile IP is used, a home agent (HA) performs the IP address assignment procedure. When the IP address assignment procedure has been completed, IP packet communication is initiated for a data service using the assigned IP address.

In accordance with the present invention, the IP packet can be transmitted from the PDSN to the MS without the PPP layer connection between the MS and the PDSN.

In accordance with another aspect of the present invention, the RN must determine whether the MS supports the packet data service method of the present invention so that the mobile communication network can support both the inventive data service method and the conventional data service method. In accordance with the present invention, the determination is made by checking a service option number at a traffic channel setup step for data communication while a call setup procedure is performed between the MS and the RN.

The above and other aspects will be apparent from the following embodiments.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic block diagram illustrating the architecture of a conventional third Generation Partnership Project 2 (3GPP2) network;

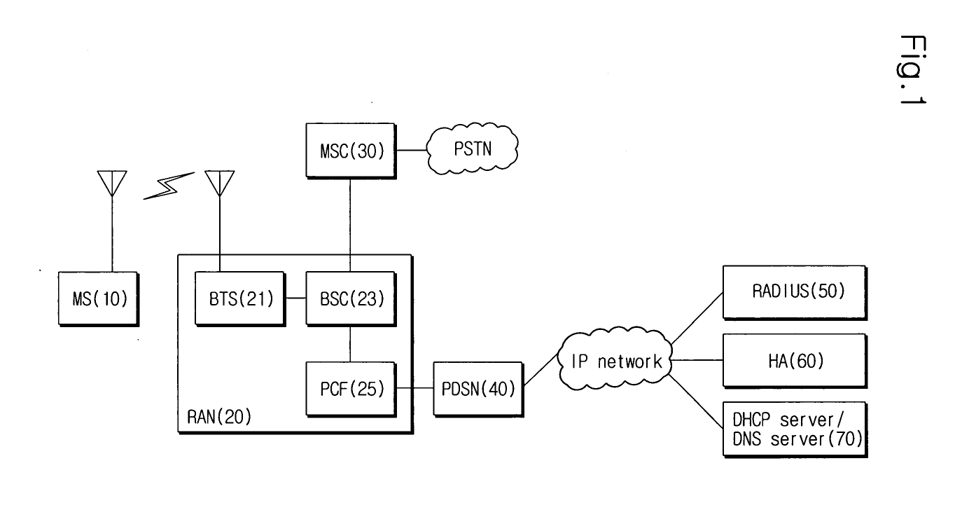

FIG. 2 is a schematic diagram illustrating a protocol stack for a data call connection in a conventional mobile communication system;

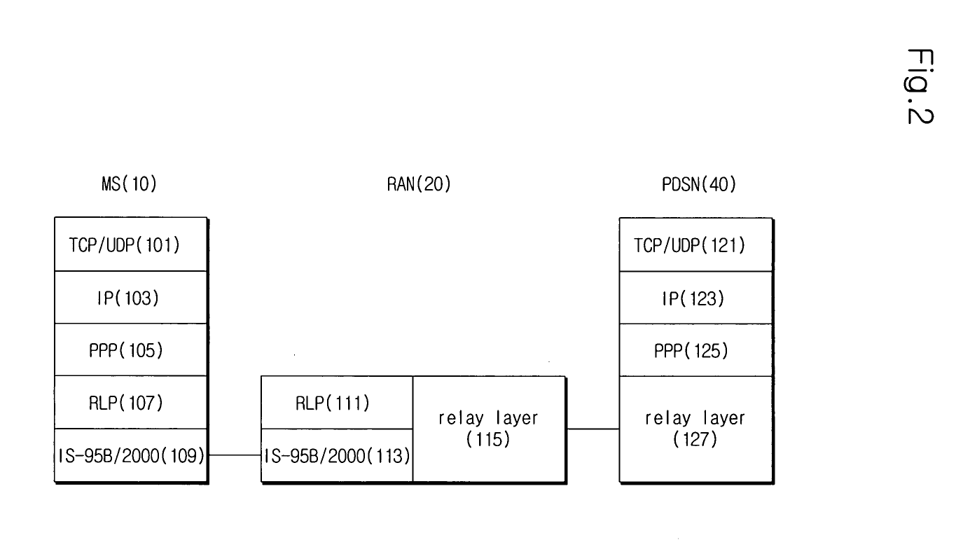

FIG. 3 is a flow chart illustrating a connection process for a packet data service in a conventional mobile communication network;

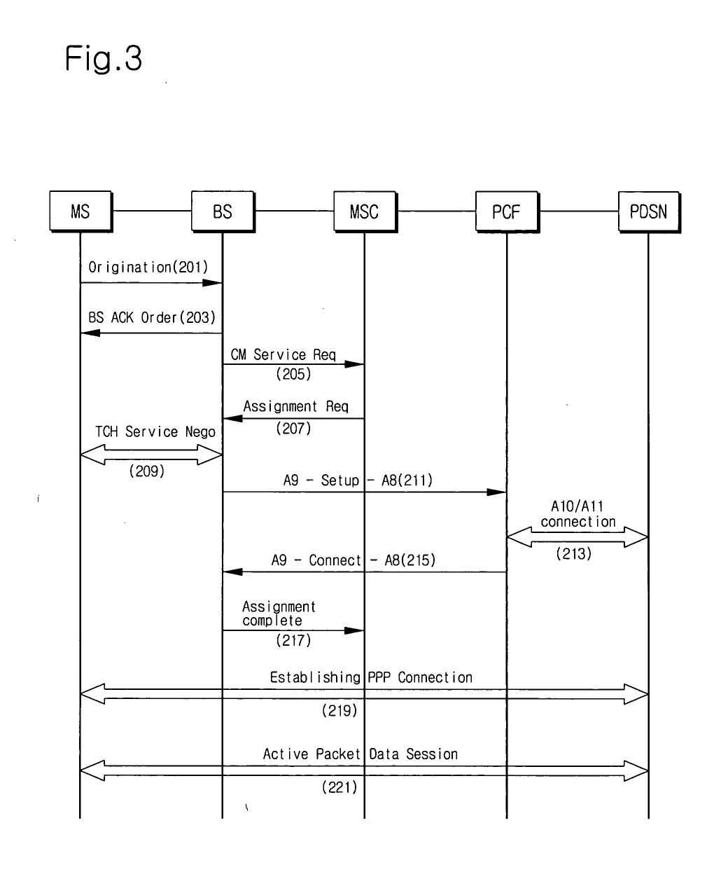

FIG. 4 is a schematic diagram illustrating a protocol stack for a data call connection in a mobile communication system in accordance with one preferred embodiment of the present invention; and

FIG. 5 is a flow chart illustrating a connection process for a packet data service in the mobile communication system in accordance with one preferred embodiment of the present invention.

### DESCRIPTION OF THE PREFERRED EMBODIMENTS

Now, preferred embodiments in accordance with the present invention will be described in detail with reference to the annexed drawings so that the present invention can be readily understood.

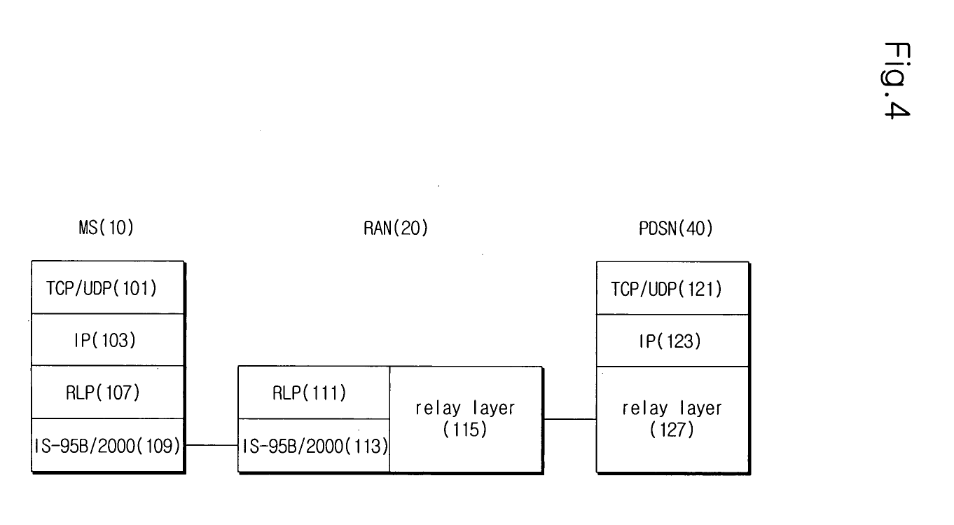

FIG. 4 is a schematic diagram illustrating a protocol stack for a data call connection in a mobile communication system in accordance with one preferred embodiment of the present invention. In the mobile communication system supporting the data call connection in accordance with the present invention as shown in FIG. 4, a mobile station (MS) 10 maintains a traffic channel and a radio link protocol (RLP) link with a radio access network (RAN) or a radio network (RN) 20 on the basis of an IS-95B/2000 109 and an RLP 107 for a physical layer.

In accordance with the present invention, the MS 10 based upon the protocol stack shown in FIG. 4 includes a packet service requesting part for performing a radio packet access procedure through the packet data serving node (PDSN) 40, and a packet transceiver for transmitting/receiving packet data when the packet service access procedure has been completed. The packet service requesting part transmits a packet service access request message to the RN 20 and transmits MS authentication data to the PDSN 40 through the RN 20 in the form of an Internet protocol (IP) message. When the packet service access procedure has been completed, the packet transmitting/receiving part exchanges packet service data with the PDSN 40 without going through a point-to-point protocol (PPP) layer. In accordance with the present invention, the packet service requesting part contains an indicator indicating that the PPP is not used, in the service access request message and then transmits the service access request message containing the indicator.

The RN 20 supports RLP and IS-95B/2000 protocol corresponding to those of the MS 10.

On the other hand, a virtual connection between the RAN 20 and the PDSN 40 is set up and maintained by relay layers 115 and 127. Of course, there are IP layers, link layers and physical layers for supporting IP communication between two computers.

IP layers 103 and 121 and TCP/UDP layers 101 and 121 maintain the connection between the MS 10 and the PDSN 40. As shown in FIG. 4, PPP layers for interconnecting two devices are not present, but the connection between the two devices is maintained by the IP layers.

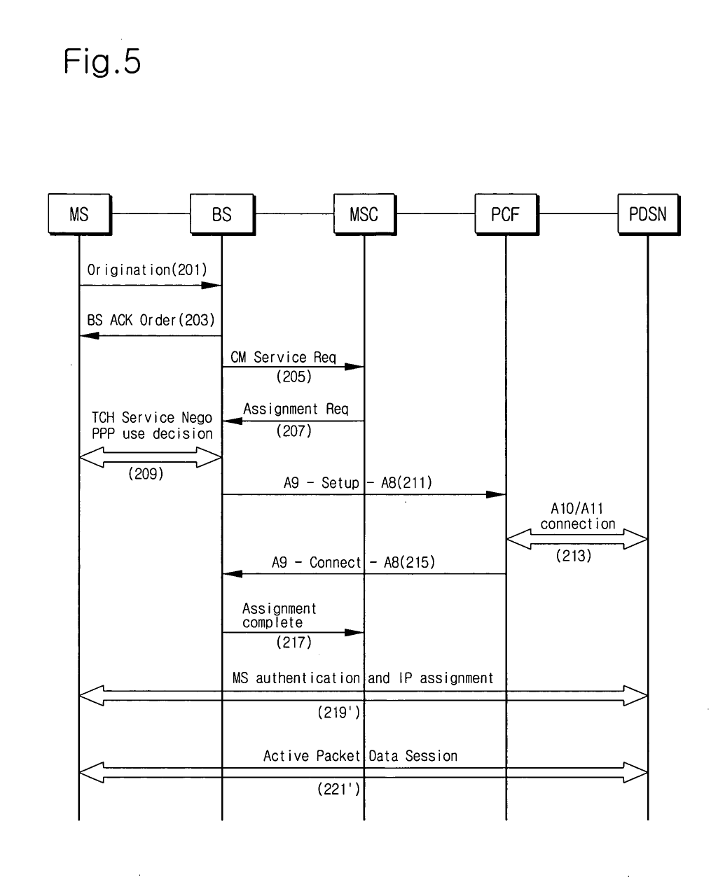

FIG. 5 is a flow chart illustrating a connection procedure for a packet data service in the mobile communication system in accordance with one preferred embodiment of the present invention. A radio network (RN) of the mobile communication system includes a base station (BS), a mobile switching center (MSC) and a packet control function (PCF) entity. A packet data serving node (PDSN) serves as an Internet interface device.

As shown in FIG. 5, the packet data service connection procedure is initiated when the MS transmits an origination message to the BS at step 201, as in the conventional packet data service connection procedure. The BS transmits, to the MS, a “BS ACK Order” message indicating that the BS has received the origination message at step 203. Then, the BS transmits, to the MSC, a “CM Service Request” message to notify the MSC of a packet call request at step 205. Then, the MSC transmits, to the BS, an “Assignment Request” message to request that the BS assign radio resources at step 207. Then, service negotiation is performed between the MS and the MSC, such that a traffic channel (TCH) is set up between the MS and the RN at step 209.

In accordance with the present invention, the service negotiation procedure can additionally include a step of allowing the RN to communicate with the MS and to determine whether or not a PPP layer connection must be used. That is, when the service negotiation procedure is carried out, the BS determines whether or not the MS supports a communication procedure of the present invention, by confirming a specific indicator transmitted from the MS, e.g., a service field. If the MS supports the communication procedure of the present invention, that is, the MS does not use the PPP layer connection, the BS notifies the PDSN of the fact that the MS does not use the PPP layer connection so that the data communication method can be applied in accordance with the present invention. On the other hand, if the MS does not support the communication procedure of the present invention, that is, the MS uses the PPP layer connection, the packet data service is rejected or a session is set up through the PPP layer connection based upon the conventional communication method so that an IP packet can be exchanged and processed.

In accordance with the preferred embodiment of the present invention, the discrimination between a call in the conventional method using the PPP and a call in the inventive method without using the PPP can be achieved on the basis of a service option number such as a service option 33 (corresponding to a 144-kbps packet data service for interim standard-2000 (IS-2000), Internet or ISO protocol stack-TSB58B) for IS-2000 (based upon a high-speed packet data service). The service option number includes 16 bits. The most significant bit of the service option number is a proprietary indicator. Bits 2 to 4 indicate a base service option number and the remaining 12 bits indicate a service option revision number. In this embodiment, the BS checks the proprietary indicator being the most significant bit of the service option number and the base service option number. The number “33” is used as the base service option number in the service option number transmitted from the MS. If the proprietary indicator bit is “1”, the call setup method in accordance with the present invention is performed.

In another embodiment, the BS can perform the step of allowing the RN to communicate with the MS and to determine whether or not a PPP layer connection must be used, according to the received origination message, when the MS initially transmits the origination message to the BS at the above step 201. When the determination is performed in relation to a voice call as well as a data call, unnecessary delay can be incurred. However, the unnecessary delay associated with the voice call can be removed in this embodiment performing the service negotiation process.

In another embodiment of the present invention, the MS may not perform a PPP layer connection according to whether or not a packet service system including the BS provides the PPP layer connection. That is, the MS receives, from the BS, identification information indicating whether or not the MS must use the PPP layer connection, such that the MS performs the PPP layer connection procedure or can omit the PPP layer connection procedure according to the identification information.

Then, a packet connection is set up between the BS and the PDSN. That is, the BS transmits an “A9-Setup-A8” message for packet control function (PCF) resource assignment to a PCF entity at step 211. The PCF entity sets up an A10/A11 connection for generic routing encapsulation (GRE) session assignment with the packet data serving node (PDSN) at step 213. Then, the PCF entity transmits an “A9-Connect-A8” message as a response associated with PCF resource assignment to the BS at step 215. The BS transmits, to the MSC, an “Assignment Complete” message indicating that resource assignment has been completed at step 217.

In accordance with the present invention, necessary information is exchanged between the MS and the PDSN at step 219′. For example, the necessary information includes packet service authentication data of the MS such as a packet service user identity (ID) and a password. The packet service user ID and the password are transmitted to a remote authentication dial-in user service (RADIUS) server serving as an authentication server through the PDSN, such that the RADIUS server can authenticate the user.

In accordance with the present invention, necessary information necessary for performing IP address assignment and DNS information transmission is exchanged using a broadcast/multicast IP packet. That is, the PDSN serves as an authentication client corresponding to the RADIUS server, and is connected to the RADIUS server so that the PDSN receives an assigned IP address and DNS information from the RADIUS server. A dynamic host configuration protocol (DHCP) server can transmit the IP address and the DNS information in place of the RADIUS server. Furthermore, where a mobile IP is used, a home agent (HA) can transmit the IP address and the DNS data. The PDSN transfers the assigned IP address and the received DNS data to the MS through the broadcast/multicast IP packet based upon the IP layer. A traffic channel is assigned between the MS and the RN and a one-to-one connection is ensured between the MS and the RN. As the RN and the PDSN maintain a GRE session, information can be appropriately transmitted to a target MS through the broadcast/multicast IP packet. That is, the PDSN serves as a broker or agent when the information is transmitted in accordance with the present invention.

When the IP address has been assigned, the MS establishes a session with the PDSN through the RN and exchanges an IP packet with the PDSN at step 221′. At this point, the PDSN and the MS exchange the IP packet. However, the IP packet and the PPP packet are mutually converted in the conventional technology. In accordance with the present invention, the MS and the PDSN convert an IP packet into an RLP packet.

As apparent from the above description, the present invention can omit an operation going through a point-to-point protocol (PPP) layer to remove unnecessary information associated with the operation and time delay incurred by a mutual conversion operation for a PPP packet and an Internet protocol (IP) packet, in a mobile communication process.

Although the preferred embodiments of the present invention have been disclosed for illustrative purposes, those skilled in the art will appreciate that various modifications, additions and substitutions are possible, without departing from the scope of the invention. Accordingly, the present invention is not limited to the above-described embodiments, but the present invention is defined by the claims which follow, along with their full scope of equivalents.

1. A method for providing a mobile packet data service in a mobile communication network, comprising the steps of:
(a) setting up a traffic channel between a mobile station (MS) and a radio network (RN);
(b) setting up a virtual connection between the RN and a packet data serving node (PDSN);
(c) allowing the PDSN to transmit Internet protocol (IP) data to the MS without setting up a point-to-point protocol (PPP) layer connection; and
(d) allowing the MS and the PDSN to exchange an IP packet through the RN.

2. The method as set forth in claim 1, wherein the RN provides an interim standard-2000 (IS-2000) system.

3. The method as set forth in claim 1, wherein a transmission operation for the IP information at the step (c) is carried out using a broadcast/multicast IP packet.

4. The method as set forth in claim 1, wherein the step (a) includes the step of:
(a1) determining whether or not the PPP layer connection must be used.

5. The method as set forth in claim 4, wherein said step c) comprises the step of
c1) setting up a point-to-point protocol (PPP) layer connection if the PPP connection must be used as a result of the determination at said step (a1),
c2) allowing the PDSN to transmit Internet protocol (IP) data to the MS through the point-to-point protocol (PPP) layer connection if the PPP connection must be used as a result of the determination at said step (a1)

6. The method as set forth in claim 4, wherein the determination at the step (a1) is based upon a most sgnificant bit contained in a code division multiple access (CDMA) service option number.

7. A system for providing a mobile packet data service, comprising:
at least one mobile station (MS);
a radio network (RN) for performing data communication with the MS; and
a packet data serving node (PDSN) for transmitting and receiving packet service data via at least one necessary protocols other than a point-to-point protocol (PPP).

8. The system as set forth in claim 7, wherein the MS and the PDSN transmit and receive MS authentication data for a packet service in the form of a IP packet.

9. A mobile packet data terminal, comprising:
a packet service requesting part for transmitting a packet service access request message to a radio network (RN) in accordance with a packet service access procedure, and transmitting mobile station (MS) authentication data for a packet service to a packet data serving node (PDSN) though the RN in the form of a IP message; and
a packet transmitting/receiving part for transmitting and receiving packet service data to and from the PDSN through the RN without going through a point-to-point protocol (PPP) layer when the packet service access procedure has been completed.

10. The mobile packet data terminal as set forth in claim 9, wherein the packet service requesting part contains an indicator indicating that the PPP is not used, in the packet service access request message, and transmits the packet service access request message containing the indicator.
